(19) United States
(12) Patent Application Publication
(10) Pub. No.: US 2012/0041814 A1
(43) Pub. Date: Feb. 16, 2012

(54) METHOD OF CREATING A COMMUNITY USING SEQUENTIAL NUMBERING

(76) Inventor: Peter Kraft, Morris Plains, NJ (US)

(21) Appl. No.: 13/207,064

(22) Filed: Aug. 10, 2011

Related U.S. Application Data
(60) Provisional application No. 61/372,151, filed on Aug. 10, 2010.

(51) Int. Cl. G06Q 30/00; G06Q 99/00; G06K 19/06

(52) U.S. Cl. 705/14.36; 235/494; 705/319

(57) ABSTRACT

The creation of a fan based community as an affinity marketing platform. The community members are classified by a user number linked to the priority of their claim for affinity with the organization. Their user numbers are posted on a web-page having a unique URL. The user is issued with a tag that displays the user number and a machine readable QR code that encodes the

URL containing information about the user. Affinity marketing to the group can include opportunities such as fan number call-outs, “rush” campaigns that include free merchandise, seat upgrades, club or suited access, invitations to watch practice, autographs, concession and stadium-wide promotions to fans with a particular digit in their fan number.

### CLAIM OF PRIORITY

This application claims priority to U.S. Provisional Application 61/372,151 filed on Aug. 10, 2010, the contents of which are hereby incorporated by reference.

### FIELD OF THE INVENTION

The invention relates to an affinity marketing method and tag, and more particularly to marketing using a user number that corresponds, in part, to a temporal order in which the member joined a group, and in which a wearable physical tag is used to display both the number, a machine readable indicia indicative of a cyber location containing information linking the user number to the member of the group, and a indicator of a level of acknowledged allegiance of the member to the group.

1. Background of the Invention

Social networking sites such as, but not limited to, Facebook and Twitter, have become important elements of many brands and companies advertising campaigns. While use of such networking sites may be very effective in communicating with existing and potential customers, a major drawback for the companies and brands that use the existing social networks is that they do not own the data about their customers or fans, the social network site does.

The present invention addresses this problem by first issuing Official Fan Numbers to give supporters a sense of identity, status and ownership in the team, brand or company they are backing. These numbers may also become a badge of belonging and serve as a networking gateway.

In addition, these fan numbers may be used to create a number of engagement experiences. By providing a fan with both a unique fan number, and a machine readable indicia such as, but not limited to, a QR code, a variety of marketing opportunities may be created such as, but not limited to, fan number call-outs, “rush” campaigns that may, for instance, include free merchandise, seat upgrades, club or suited access, invitations to watch practice, autographs, concession and stadium-wide promotions that may, for instance, take the form of anyone with a “7” in their fan number getting a $2 discount on a hot dog, or some combination thereof.

2. Description of the Related Art

The relevant prior art includes:

U.S. Pat. No. 7,784,703 issued to Walmsley, et al. on Aug. 31, 2010 entitled “Data tag with a position detection pattern” that describes a two-dimensional printed data tag for detection by an optical tag reader has a position detection pattern configured so that an optical tag reader can locate the tag. Data areas are located within the confines of the position detection pattern, the data areas containing encoded data.

U.S. Pat. No. 7,882,438 issued to Markham, et al. on Feb. 1, 2011 entitled “Quality management and intelligent manufacturing with labels and smart tags in event-based product manufacturing” that describes a method of providing quality management and intelligent manufacturing with labels and smart tags in event-based product manufacturing. Some of the disclosed embodiments include a system, method, and computer-readable media for storing, during a process, data associated with a material. Also disclosed are a method of collecting, storing, and reporting machine productivity, waste, and delay information on an event basis in a manufacturing system, a method of capturing and storing material history, a method of automating tracking of positions of components used in a process and correlating portions of a component with production problems, an improved inventory management system, and a method of tracking and recording actions of specific operators of a process performed by a machine. The embodiments are operable in an intelligent manufacturing system including a process for converting raw materials to a product, a process control system including one or more sensors capable of generating an alarm in response to an event that results in one of waste, machine delay, or decrease product quality, a data logger associated with the process control system for obtaining event parameters associated with the event, a database on a server for recording event parameters obtained by the data logger, and a reporting system cooperatively associated with the database for reporting productivity parameters regarding the process derived at least in part from the event parameters.

U.S. Patent Application 20110029364 by Roeding; Cyriac; et al. published on Feb. 3, 2011 entitled “Method and System for Presentment and Redemption of Personalized Discounts” that describes a presentment and redemption system offers discounts directly to consumers through their mobile phones. The discounts are based upon the user of the mobile phone meeting a targeting criterion and the discounts are determined using the targeting criterion. Mobile phone users that do not meet the targeting criterion are not eligible for the discount. Because the discounts can be targeted to each individual consumer, there can be a better correlation between consumers' interests and the transmitted discounts.

Various implements are known in the art, but fail to address all of the problems solved by the invention described herein. One embodiment of this invention is illustrated in the accompanying drawings and will be described in more detail herein below.

### SUMMARY OF THE INVENTION

The present invention relates to a method of creating a fan community, and methods of using that fan based community as an affinity marketing platform.

In a preferred embodiment, the fan based community may be a group that has one or more users claiming an affinity to an organization. These users may then be classified by a user number that may be inductive of a priority of their claim for affinity with the organization.

The user number may then be posted at a cyber location such as, but not limited to, a web-page having a unique uniform resource locater (URL), and which may also contain further information about the user that may be supplied by the user.

In a preferred embodiment, the user may then be issued with an affinity marketing tag that may, for instance, be a durable surface, such as, but not limited to, a badge or a name tag that displays the user's user number in human readable form and a machine readable indicia such as, but not limited to, a QR code that is the URL of the cyber location. The cyber location may contain information about the user and may also include an indication of the degree of affinity they have for the group.

Having established a community of users having user numbers corresponding, in part, to a temporal order in which the user joined the group, and having wearable affinity marketing tags displaying their user number and a URL of a location of further information, an affinity marketing program may be implemented. The affinity marketing may, for instance, include marketing opportunities such as, but not limited to, fan number call-outs, “rush” campaigns that may, for instance, include free merchandise, seat upgrades, club or suited access, invitations to watch practice, autographs, concession and stadium-wide promotions that may, for instance, take the form of anyone with a “7” in their fan number getting a $2 discount on a hot dog, or some combination thereof.

Therefore, the present invention succeeds in conferring the following, and others not mentioned, desirable and useful benefits and objectives.

It is an object of the present invention to provide a means of creating a social experience between an audience and a brand.

It is another object of the present invention to provide customized, or “skinned” mobile applications that allow an audience to connect with a brand and to participate in marketing campaigns initiated by the brand.

Yet another object of the present invention is to provide an engagement program to connect a brand to an audience.

Still another object of the present invention is to provide an engagement algorithm that monitors, influences and rewards people's engagement actions based on the brand's objectives.

Still another object of the present invention is to provide a “bragtag” to brag about their membership to, or inclusion in, a brand.

Yet another object of the present invention is to provide tiered levels of bragtags that offer superior rewards but that may only be obtained by paying or passing predefined engagement activity milestones.

### BRIEF DESCRIPTION OF THE DRAWINGS

FIG. 1 shows a preferred embodiment of present invention.

FIG. 2 shows a schematic flow chart illustrating steps of an enrollment procedure of an embodiment of the present invention.

FIG. 3 shows a schematic flow chart illustrating steps of a fan challenge according to an embodiment of the present invention.

FIG. 4 shows a schematic flow chart illustrating steps of another fan challenge according to an embodiment of the present invention.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

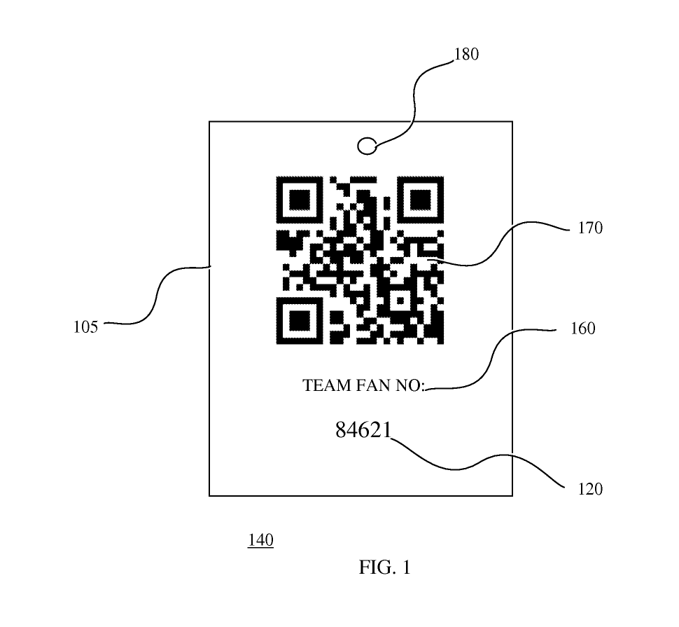

FIG. 1 shows a preferred embodiment of a wearable physical tag 140 of the present invention.

In this preferred embodiment, the wearable physical tag 140 may be an affinity marketing tag 105 that may, for instance, be any suitable durable surface, such as, but not limited to, a cloth or metal badge, a paper, plastic or laminated name tag, a printed sweat or T-shirt, or some combination thereof.

The affinity marketing tag 105 may have a physical manifestation of the user number 120 that may correspond, at least in part, to a temporal order in which the member joined a particular group that issued the affinity marketing tag 105. The number may be displayed in Arabic numerals, Roman numerals, binary, octal or any other format that may be relevant to the group supplying the affinity marketing tag 105. The number may also use letters or emoticons in part, or in whole, to designate the temporal order.

The affinity marketing tag 105 may also have a machine-readable indicia 170. The machine readable indicia 170 may, for instance, be indicative of a cyber location containing information linking the user number to the member of the group.

The machine readable indicia 170 may, for instance, be a barcode that is an optical machine-readable representation of data that may be in one or two-dimensional, in linear, matrix or circular format and may include popular formats such the Quick Recognition (QR) Code that is readable by many modern phones that have built in cameras.

The affinity marketing tag 105 may also have an indicator of the group, or brand to which the user is proclaiming allegiance. This indicator may also have some showing of the level of acknowledged allegiance of the member to the group such as, but not limited to, a number of stars, a colored swish or a statement such as, but not limited to, level 1 team fan, loyal supporter for since the 2005 season, attended every game in the 2010 season, or some combination thereof.

The affinity marketing tag 105 may also have one or more attachment points for wearing 180. These may be structures such as, but not limited to, a hole for a lanyard, a clip for attaching to clothing, a ring for attaching to a support or some combination thereof.

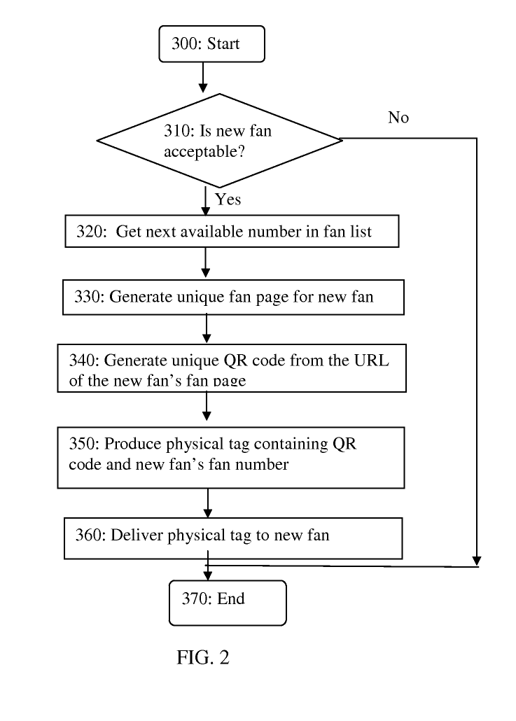

FIG. 2 shows a schematic flow chart illustrating steps of an enrollment procedure of an embodiment of the affinity marketing method 100 of the present invention.

In step 300: Start, the enrollment process may be started by, for instance, by activating a computer program operative on a general purpose computer such as, but not limited to, a processor running an application on a smart-phone.

In step 310: Is new fan acceptable?, a preprogrammed software application may make an assessment of a persons suitability to become a member of a group. The assessment may, for instance, be made based on any suitable demographic or other information that the applicant may have revealed in response to a questionnaire or the like, such as, but not limited to, age, gender, ethnicity, place of education, current work, residence address, current zip code, prior attendance at a team event, commitment to a particular social, religious or political cause, or some combination thereof.

If the answer is no, the software module may proceed to step 370: End, and terminate the process.

If step 310 is successful, then in step 320: Get next available number in fan list, the software module, or application, may search a database to obtain the next available fan number.

In step 330: Generate unique fan page for new fan, the software module may then generate a web-page for the new fan.

In step 340: Generate unique QR code from the URL of the new fan's fan page, the software module may use the URL of the new fan web-page it has just created to form a QR code matched to the new fan number.

In step 350: Produce physical tag containing QR code and new fan's fan number, the software model may directly, or indirectly, cause an affinity marketing tag 105 containing both the user number 120 and the indicia indicative of the cyber location 150, to be produced as a wearable physical tag 140.

In step 360: Deliver physical tag to new fan, the software module may directly, or indirectly, cause the affinity marketing tag 105 to be delivered to the user.

The software module may then cease operation in step 370: End.

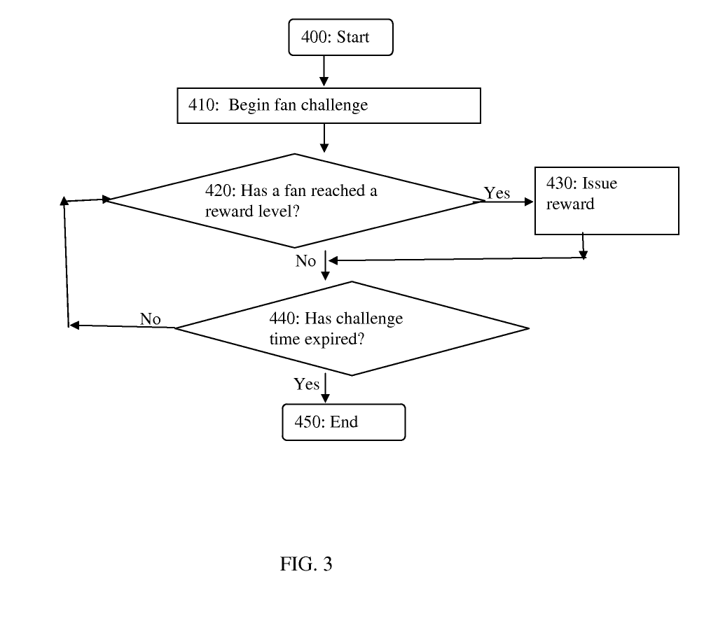

FIG. 3 shows a schematic flow chart illustrating steps of a fan challenge according to an embodiment of the present invention.

In step 400: Start, a fan challenge may be initiated by an operator activating a software module.

In step 410: Begin fan challenge, the contest may begin. The contest may take the form of a challenge such as, but not limited to, users exchanging their information containing cyber locations by photographing each others QR tag, with a user obtaining the most QR tags within a given time, or someone reaching a predetermined number of new QR tags within a given time, becoming a winner.

In step 420: Has a fan reached a reward level, a contest moderator may make use of data from an application monitoring user activity to determine if any user has achieved a reward status. If a reward status has been achieved, then in step 430: Issue reward, the winner may be sent notification of the reward by any suitable means such as, but not limited to, email, instant message, announcement over a stadium PA system, notification on a stadium large screen TV, or some combination thereof.

In either case, the application may then proceed to step 440: Has challenge time expired? If the predetermined time for the challenge has not yet expired, the software may loop aback and repeat step 420: Has a fan reached a reward level?

If the predetermined time for the challenge has expired, the software may then proceed to step 450: End, and terminate.

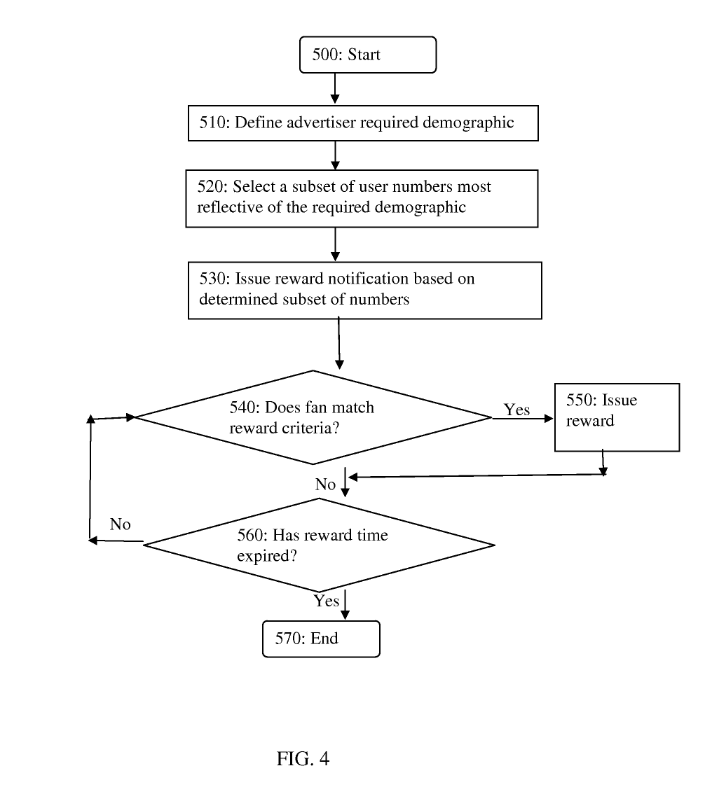

FIG. 4 shows a schematic flow chart illustrating steps of another fan challenge according to an embodiment of the present invention.

In step 500: Start, a software module may be activated by contest organizer.

In step 510: Define advertiser required demographic, the software module may be supplied with contestant demographics required by an advertiser, or by a sponsor of part, or all, of the contest.

In step 520: Select a subset of user numbers most reflective of the required demographic, the software module may interrogate a user database to determine a subset of users that match the sponsor required demographic.

In step 530: Issue reward notification based on determined subset of numbers, the software module may be used to notify the selected users of the terms of the contest or promotion. The notification may be made by any suitable means such as, but not limited to, email, instant message, announcement over a stadium PA system, notification on a stadium large screen TV, or some combination thereof.

The contest or promotion may, for instance, take the form of a game or stunt such as, but not limited to, rewarding a user based on one or more elements of their number, of their zip code, or their standing in a leader board that may be indicative of the level of their participation in past promotions, contests or fan challenges, or some combination thereof.

In step 540: Does fan match reward criteria? A moderator, assisted by the software program, may make a determination on whether or not a fan matches the promotion reward criteria.

If a fan meets the reward criteria, then in step 550: Issue reward, the reward, or a notification of the reward, may be issued to that fan.

Whether or not a reward is issued, the software program may then move on to step 560: Has reward time expired?

If the time has not expired, the software program may loop back to, and repeat, step 540: Does fan match reward criteria?

If the time has expired, the software may move to step 570: End and terminate.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. An affinity marketing method, comprising:
issuing a member of a group a user number corresponding, in part, to a temporal order in which said member joined said group; and
creating a physical manifestation of said user number, said physical manifestation comprising:
displaying said number, or a relevant portion thereof, on a wearable physical tag in human readable form; and
displaying, on said physical tag in optical, machine-only readable form, an indicia indicative of a cyber location containing information linking said user number to said member of said group, said information comprising an indicator of a level of acknowledged allegiance of said member to said group.

2. The affinity marketing method of claim 1 wherein said user number further corresponds, in part, to a demographic of said member.

3. The affinity marketing method of claim 1 wherein said user number further corresponds, in part, to a member's zip code.

4. The affinity marketing method of claim 1 wherein said wearable physical tag is one of an item of clothing or a wearable accessory item.

5. The affinity marketing method of claim 1 wherein said cyber location is an Internet URL and said information linking said user number to said member of said group comprises information relevant to said member's social commitment.

6. The affinity marketing method of claim 1 wherein said machine readable indicia is a QR tag.

7. The affinity marketing method of claim 1 wherein said information relevant to said member's social commitment comprises publically readable information.

8. The affinity marketing method of claim 1 further comprising creating a fan challenge comprising two or more users exchanging with each other said cyber locations of information relevant to them.

9. The affinity marketing method of claim 8 further comprising generating and displaying a leader board, said leader board being indicative of one or more users participation is said fan challenge.

10. The affinity marketing method of claim 9 further comprising rewarding a user based on said user's standing in said leader board.

11. The affinity marketing method of claim 1 further comprising rewarding a user based on one or more elements of said number.

12. The affinity marketing method of claim 11 wherein said rewarding a user based on one or more elements of said number further comprise selecting said elements to select members having a predetermined demographic profile.

13. The affinity marketing method of claim 12 wherein selecting said elements comprises selecting one or more zip codes.

14. The affinity marketing method of claim 1 wherein said number is displayed as one of Roman numerals or binary numerals.

15. An affinity marketing tag, comprising:
a durable surface displaying a number in human readable form and a machine readable indicia, and wherein said number is indicative of an order in which a user joined a group, and wherein said machine readable indicia is a QR code comprising a URL of a cyber location containing information relevant to said user.

16. The affinity marketing tag of claim 15 wherein said URL is publically accessible.

17. The affinity marketing tag of claim 15 wherein said durable surface is shaped and sized to be wearable by said user as clothing or as an accessory.

18. A method of creating a fan based community, comprising:
defining a group as being one or more users claiming an affinity to an organization;
classifying said users by a user number inductive of a priority of said claim for affinity;
posting said number at a cyber location;
generating a machine readable indicia indicative of said cyber location; and
providing a user with an affinity marketing tag, comprising:
a durable surface displaying said user number in human readable form and a machine readable QR code comprising a URL of said cyber location.
